(19) United States
(12) Patent Application Publication
(10) Pub. No.: US 2016/0118922 A1
(43) Pub. Date: Apr. 28, 2016

(54) Drive battery for in-phase operation of an electric motor, drive system and a method for operating the drive system

(71) Applicant: Robert Bosch GmbH, Stuttgart (DE)

(72) Inventor: Uwe RAUSCHER, Hohenstein (DE)

(21) Appl. No.: 14/889,375

(22) PCT Filed: May 7, 2014
(86) PCT No.: PCT/EP2014/059341

§ 371 Date: Nov. 5, 2015

(30) Foreign Application Priority Data
May 8, 2013 (DE) 10 2013 208 583.4

(51) Int. Cl. H02P 25/16

(52) U.S. Cl. CPC H02P 25/16

(57) ABSTRACT

A drive battery for n-phase operation of an electric motor includes at least 2*n battery strings each including a plurality of series-connected battery cells. At least one battery cell per battery string is selectively connectable and disconnectable from the particular battery string by activation of a coupling circuit associated with the particular battery cell. Each battery string is also connectable to one of 2*n pole windings of an n-phase operable electric motor, where nεN⁺ and n>1. Two of the at least 2*n battery strings are each designed to generate an always phase-synchronous alternating voltage by activation of the coupling circuits of their particular battery cells.

### BACKGROUND OF THE INVENTION

1. Field of the Invention

The present invention relates to a drive battery for n-phase operation of an electric motor, which has at least 2*n battery strings as well as a drive system and a method for operating the drive system.

2. Description of the Related Art

Electromobility is playing an increasingly important role in present and future generations of automobiles. Electric drives are used either as a complete alternative to the known internal combustion engine or in support of an internal combustion engine in so-called hybrid vehicles. In the related art, the concept of these drives presently includes a traction battery or a drive battery including series-connected battery cells, a corresponding intermediate circuit including an intermediate circuit capacitor and an inverter, which converts the intermediate circuit voltage, i.e., the direct voltage, into the required n-phase voltage, but mostly a 3-phase sinusoidal voltage.

The drive batteries of the related art typically include a plurality of lithium-ion battery cells, which may be operated only in a very limited temperature and voltage range. Furthermore, lithium-ion battery cells must not be charged beyond a predetermined threshold or discharged below a predetermined threshold. To ensure that the battery cells are always being operated at the operating points derivable from the aforementioned conditions, sensor systems in the form of monitoring circuits are often used in state-of-the-art drive batteries.

The voltage and temperature of each battery cell are therefore detected by a monitoring circuit and the information about these parameters is forwarded to a central unit. Such monitoring circuits often provide means for active or passive balancing of the battery cells, via which the charge state of the battery cells is adapted among one another. The monitoring circuits are typically installed together with the battery cells. The so-called intermediate circuit voltage, which is a direct voltage, usually of approximately 400 V to 500 V, is supplied by the drive battery and conducted to the inverter. The inverter, which is a so-called pulse controlled inverter (PCI), converts the direct voltage into a mostly 3-phase alternating voltage, which is conducted directly to the electric machine or the electric motor. The electric motor rotates as a function of the frequency of this alternating voltage and varies the speed of the vehicle accordingly. The pulse controlled inverter generally operates with so-called insulated gate bipolar transistors (IGBTs), which are situated in a B6-bridge configuration and are also capable of generating negative voltages of mostly three phases.

An alternative concept to the topology described above is the so-called “ALETO” concept, which in turn provides two different configurations, which are known as direct inverter (DINV) concepts and direct converter (DICO) concepts. Both of these concepts intervene in the topology of the drive battery described previously. For example, in the direct inverter concept, the drive battery is divided into individual battery modules, for example, 12 battery cells, each being connectable to the drive battery and disconnectable from the drive battery, i.e., designed to be bridgeable more or less in the manner of a bypass. There is a further refinement of this “ALETO” concept with the so-called “smart cell” concept, where battery modules including a certain number of series-connected battery cells are no longer designed to be disconnectable from or connectable to the drive battery, but instead each battery cell is switched separately, so it is separately connectable to or disconnectable from the drive battery, just like the battery modules in the “ALETO” principle.

The individual battery cells are connected and disconnected via switching means, which are interconnected to one another in a coupling circuit, mostly in a half-bridge or full-bridge configuration, and to the corresponding battery cell, as was already the case with the battery direct inverter or battery direct converter principle. The switching means of these coupling circuits must always be capable of carrying the current of the entire string, which is presently allowed to exceed a level of 480 amperes, for example. However, such high currents constitute a high load for the switching means of the coupling circuit, which, according to the related art, must be taken into account in a mostly expensive design of the switching means of the coupling circuit.

### BRIEF SUMMARY OF THE INVENTION

According to the present invention, a drive battery for n-phase operation of an electric motor is provided, including at least 2*n battery strings, each battery string including a plurality of series-connected battery cells, and at least one battery cell per battery string is connectable to the particular battery string and disconnectable from the particular battery string per activation of a coupling circuit associated with the particular battery cell. Furthermore, each battery string is connectable to one of 2*n pole windings of an n-phase-operable electric motor, where nεN⁺ and n>1 apply. According to the present invention, of the at least 2*n battery strings, two of their particular battery cells per activation of the coupling circuits are designed to generate an always phase-synchronous alternating voltage. In other words, of the at least 2*n battery strings, two of them are designed to generate an always phase-synchronous alternating voltage by phase-synchronous connection or phase-synchronous disconnection of their particular battery cells.

The advantage of such a drive battery is that at least 2*n* battery strings are available for generating the alternating voltages of the n phases for an n-phase electric motor, i.e., two or more battery strings are available per phase, so that the current is reduced by one-half or even more per battery string in comparison with the related art. Therefore, this greatly reduces the load on the coupling circuits or the switching means of the coupling circuits, which are used for connecting or disconnecting the battery cells. Furthermore, the installed switching means may be designed with smaller dimensions from the outset, which has a positive effect when switching relief is to be provided or has a positive effect on the avalanche resistance of the switching means. Due to the usability of simpler and smaller dimensioned switching means, the cost of implementation of the drive battery may also be reduced.

Furthermore, it is also preferable for each battery cell of the drive battery to be connectable to its particular battery string and to be disconnectable from its particular battery string per activation of a coupling circuit associated with the particular battery cell. The alternating voltage, which is thereby generatable by one battery string, is more accurately adjustable.

Preferably at least one of the battery cells per battery string has a monitoring circuit, which is designed to monitor at least one state parameter of their particular battery cell. Furthermore, the monitoring circuit is preferably designed to initialize, i.e., initiate, a measure counteracting the change in the state parameter. The service life of the drive battery may thereby be increased.

In a preferred refinement of this specific embodiment, the at least one state parameter is the battery cell voltage and/or the temperature and/or the charge state of the particular battery cell. It is therefore possible to ensure that the battery cells of the drive batteries equipped with monitoring circuits are always operated in the required operating ranges. This increases the safety and service life of the drive battery and protects the same from overvoltages or excess temperatures, for example.

Furthermore, the coupling circuits preferably have at least one switching means, which is designed in each case to carry a maximum current not in excess of a value of m/n ampere, where m ε[300 A; 1000 A], and where n corresponds to the number of phases in which the electric motor connectable to the drive battery is operable, and where nεN⁺ and n>1 apply. In a particularly preferred specific embodiment, m=480 A. In another preferred specific embodiment, m=300 A. In an additionally preferred specific embodiment, m=1000 A. In one such specific embodiment, the switching means may be implemented particularly cost-efficiently.

In a preferred refinement of this specific embodiment, the switching means are designed as power semiconductors. Power semiconductors are relatively cost-efficient and have a long service life. They may be operated at a high switching frequency and have only marginal losses.

In one further preferred specific embodiment, the switching means are designed as MOSFETs. MOSFETs are cost-efficient and very compact, i.e., they are implementable in a high integration density. Furthermore, MOSFETs have a rapid switching time and stable gain and response times.

The drive battery is preferably a lithium-ion battery. Furthermore, the drive battery preferably has lithium-ion battery cells. Advantages of such batteries and such battery cells include, among other things, their comparatively high energy density and their great thermal stability. Another advantage of lithium-ion batteries and lithium-ion battery cells is that they are not subject to a memory effect.

In addition, a drive system, including a drive battery according to the present invention and an n-phase operable electric motor, is provided, this electric motor having at least exactly as many terminals and pole windings electrically conductively connected to them as the drive battery has battery strings. One battery string of the drive battery according to the present invention is electrically conductively connected to exactly one pole winding of the electric motor via one terminal of the electric motor. Furthermore, the electric motor is operable by the drive battery according to the present invention connected to it. In other words, n, i.e., the number of different phases of the alternating voltages, with which the electric motor is operable, corresponds at most to half the number of battery strings of the drive battery. For example, the drive battery of a drive system including a 3-phase electric motor preferably has at least six battery strings, two of which are operated in phase synchronization, so that the alternating voltages generated by two battery strings are always in the same phase. Such drive systems have a longer service life than the drive systems of the related art and are also more cost-efficient.

The n-phase operable electric motor preferably has 2*n pole windings, two of which are designed to receive a mutually phase-synchronous alternating voltage for operation of the electric motor, and where nεN⁺ and n>1 applies. Such an electric motor is designed to be operated by a drive battery according to the present invention in a drive system according to the present invention in particular.

Furthermore, a method for operating a drive system, including a drive system according to the present invention, is provided. This method includes the following method step: activating the coupling circuits of the battery cells of 2*n battery strings to generate 2*n alternating voltages having n different phases, the coupling circuits being activated by two of the 2*n battery strings in phase synchronization. In other words, the coupling circuits of the activatable battery cells of the 2*n battery strings are activated in such a way that 2*n alternating voltages are generated, n of which are in a different phase from one another, i.e., two battery strings generate a phase-synchronous alternating voltage. In other words, two battery strings are activated synchronously in the same manner.

Furthermore, a motor vehicle including a drive battery according to the present invention and/or a drive system according to the present invention is/are provided.

### BRIEF DESCRIPTION OF THE DRAWING

FIG. 1 shows an exemplary embodiment of a drive system according to the present invention, including a drive battery according to the present invention.

### DETAILED DESCRIPTION OF THE INVENTION

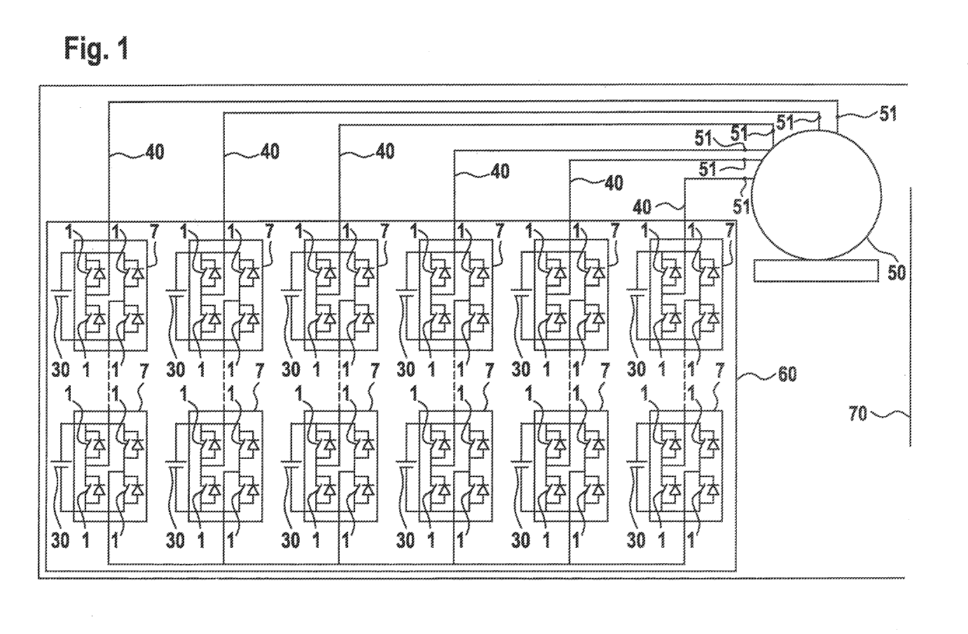

FIG. 1 shows an exemplary embodiment of a drive system 70 according to the present invention, including a drive battery 60 according to the present invention for 3-phase operation of an electric motor 50. In this exemplary embodiment, drive battery 60 according to the present invention has six battery strings 40 merely as an example, each battery string 40 including a plurality of series-connected battery cells 30. In this exemplary embodiment, merely as an example, all battery cells 30 are connectable to their particular battery strings 40 or disconnectable from their particular battery strings 40 via an activatable coupling circuit 7, via which battery cells 30 are connected or wired to their particular battery strings 40. In this exemplary embodiment, coupling circuits 7, which are activatable for connecting and disconnecting battery cells 30, are designed as full bridges. However, other drive batteries 60 and drive systems 70 may also be implemented in which coupling circuits 7 are designed, for example, as half bridges or as entirely different circuits. Furthermore, drive batteries 60 according to the present invention, in which not all battery cells 30 are disconnectable from battery strings 40 or connectable to battery strings 40, may also be implemented according to the present invention. Of the plurality of battery cells 30, FIG. 1 shows only two per battery string 40, while a remaining number of battery cells 30 per battery string 40 is indicated by a dotted line. Each battery string 40 of drive battery 60 is electrically conductively connected to one of six pole windings of a 3-phase operable electric motor 50 in this exemplary embodiment of drive system 70. Of six battery strings 40, two are designed per activation of coupling circuit 7 of their particular battery cells 30 to generate an always phase-synchronous alternating voltage. In other words, due to the phase-synchronous connection and disconnection of battery cells 30 of battery strings 40, a total of six alternating voltages assignable to battery strings 40 may be generated, two of them being in phase synchronization with one another.

In this exemplary embodiment, merely as an example, each battery cell 30 has a monitoring circuit or a monitoring circuit is assigned to each battery cell 30 (not shown), which in this exemplary embodiment is designed merely as an example to monitor the battery cell voltage, the temperature and the charge state of its particular battery cell 30. However, drive systems 70 according to the present invention may also be implemented with drive batteries 60 according to the present invention and monitoring circuits, which are designed to monitor state parameters other than those mentioned above.

In this exemplary embodiment, coupling circuits 7 of drive battery 60, designed as full bridges merely as an example, each have four switching means 1, which in this exemplary embodiment are designed merely as an example to carry a maximum current not exceeding a level of 480/3 ampere, i.e., 160 A. In other words, switching means 1 installed in coupling circuits 7 of drive battery 60 are each designed only for carrying a current not exceeding a level of 160 A. If the current flowing through switching means 1 of coupling circuits 7 of drive battery 60 exceeds this level, switching means 1 of coupling circuits 7 may incur damage.

In this exemplary embodiment, switching means 1 are designed as power semiconductors, more specifically as MOSFETs, merely as an example. However, coupling circuits 7 according to the present invention may also be designed with switching means 1, which are not power semiconductors and are not MOSFETs or different power semiconductor switches. In this exemplary embodiment, each individual one of the plurality of battery cells 30 is connectable to a battery string 40 or disconnectable from particular battery string 40 via one coupling circuit 7 each. However, drive batteries 60 according to the present invention may be implemented, in which multiple battery cells 30, for example, entire battery modules, are connectable to or disconnectable from a battery string 40 via one coupling circuit 7 each.

In other words, drive system 70 described in this exemplary embodiment includes, merely as an example, drive battery 60, which is described above, as well as a 3-phase operable electric motor 50 in this exemplary embodiment merely as an example. This electric motor has exactly the same number of terminals 51 and pole windings (not shown), electrically conductively connected to the former, as drive battery 60 has battery strings 40, i.e., six in this exemplary embodiment, merely as an example. Each battery string 40 of drive battery 60 is electrically conductively connected via one terminal 51 of electric motor 50 to exactly one pole winding of electric motor 50. Electric motor 50 is operable by drive battery 60 connected to it. Drive systems 70 according to the present invention may also be implemented, having different electric motors 50, for example, electric motors 50, which are operable as 2-phase or 4-phase motors. Drive batteries 60, which are provided for driving such electric motors 50 in drive systems 70 according to the present invention then each have at least twice as many battery strings 40 according to the present invention, i.e., at least four battery strings in the case of electric motors 50, which are operable as 2-phase motors and at least eight battery strings 40 in the case of electric motors 50 operable as 4-phase motors. Of these battery strings 40, two of these are operated in phase synchronization, i.e., in the same phase, by connecting and disconnecting battery cells 30, which are associated with battery strings 40. In other words, two battery strings 40 are designed to generate alternating voltages, each being in phase synchronization with one another. In other words, the alternating voltages generable by two battery strings 40 are yet again in phase synchronization with one another.

In this exemplary embodiment, the 3-phase operable electric motor 50 has exactly six pole windings, two of which are designed to receive an alternating voltage, each in phase synchronization with one another, for operation of electric motor 50. In other words, the 3-phase operable electric motor 50 is designed to be driven by drive battery 60, including six battery strings 40 according to the present invention.

1-10. (canceled)

11. A drive battery for n-phase operation of an electric motor, comprising:
at least 2*n battery strings, each battery string including a plurality of series-connected battery cells, and at least one battery cell of a respective battery string is selectably connectable to the respective battery string and selectably disconnectable from the respective battery string by activation of a coupling circuit associated with the respective battery cell, and each battery string is connectable to one of 2*n pole windings of an n-phase operable electric motor, wherein nεN⁺ and n>1, and wherein of the at least 2*n battery strings, two battery cells per activation of the coupling circuits are configured to generate an always phase-synchronous alternating voltage.

12. The drive battery as recited in claim 11, wherein for each respective battery string, at least one of the battery cells of the respective battery string has a monitoring circuit which is configured to monitor at least one state parameter of the at least one battery cell.

13. The drive battery as recited in claim 12, wherein the at least one state parameter is at least one of (i) the battery cell voltage, (ii) the temperature, and (iii) the charge state of the at least one battery cell.

14. The drive battery as recited in claim 11, wherein each coupling circuit has at least one switching element configured to carry a maximum current not exceeding a value of m/n ampere, wherein mε[300 A; 1000 A] and n corresponds to the number of phases with which the electric motor which is connectible to the drive battery is operable, and wherein nεN⁺ and n>1.

15. The drive battery as recited in claim 14, wherein the switching element is configured as a power semiconductor element.

16. The drive battery as recited in claim 15, wherein the switching element is configured as a MOSFET.

17. A drive system, comprising:
a drive battery for n-phase operation of an electric motor, the drive battery including:
at least 2*n battery strings, each battery string including a plurality of series-connected battery cells, and at least one battery cell of a respective battery string is selectably connectable to the respective battery string and selectably disconnectable from the respective battery string by activation of a coupling circuit associated with the respective battery cell, and each battery string is connectable to one of 2*n pole windings of an n-phase operable electric motor, wherein nεN⁺ and n>1, and wherein of the at least 2*n battery strings, two battery cells per activation of the coupling circuits are configured to generate an always phase-synchronous alternating voltage; and
an n-phase operable electric motor having the same number of terminals and pole windings electrically conductively connected as the number of battery strings of the drive battery, each battery string of the drive battery being electrically conductively connected to exactly one pole winding of the electric motor via one of the terminals of the electric motor, wherein the electric motor is operable by the connected drive battery.

18. The drive system as recited in claim 17, wherein the n-phase operable electric motor has 2*n pole windings, two of which are configured to receive respective alternating voltages which are in phase synchronization with one another, for operation of an electric motor, and where nεN⁺ and n>1.

19. A method for operating a drive system having an n-phase operable electric motor and a drive battery for n-phase operation of the electric motor, the drive battery including at least 2*n battery strings, each battery string including a plurality of series-connected battery cells, and at least one battery cell of a respective battery string is selectably connectable to the respective battery string and selectably disconnectable from the respective battery string by activation of a coupling circuit associated with the respective battery cell, and each battery string is connectable to one of 2*n pole windings of an n-phase operable electric motor, wherein nεN⁺ and n>1, and wherein of the at least 2*n battery strings, two battery cells per activation of the coupling circuits are configured to generate an always phase-synchronous alternating voltage; and the n-phase operable electric motor having the same number of terminals and pole windings electrically conductively connected as the number of battery strings of the drive battery, each battery string of the drive battery being electrically conductively connected to exactly one pole winding of the electric motor via one of the terminals of the electric motor, wherein the electric motor is operable by the connected drive battery, the method comprising:
activating the coupling circuits of the battery cells of the 2*n battery strings for generating 2*n alternating voltages having n different phases, the coupling circuits of two of the 2*n battery strings being activated in phase synchronization.
